(19) United States
(12) Patent Application Publication
(10) Pub. No.: US 2007/0274905 A1
(43) Pub. Date: Nov. 29, 2007

(54) Thermal disassociation of water

(75) Inventor: Richard L. Wynn, San Antonio, TX (US)

Correspondence Address: Charles W. Hanor;Charles W. Hanor, P.C., P.O. Box 91319, San Antonio, TX, 78209, US

(73) Assignee: Water to Gas LP

(21) Appl. No.: 11/439,566

(22) Filed: May 24, 2006

(51) Int. Cl. C01B 3/04

(52) U.S. Cl. 423/658.2

(57) ABSTRACT

An apparatus and method is provided for the ultra-high temperature cyclic thermal disassociation of water to produce usable hydrogen, oxygen, associated gases, and heat by igniting a previously-dissociated quantity of water and directing the resultant flame at a target material within a reactor whereupon the monatomic elements of the dissociated water recombine to water vapor, release energy, absorb the released energy, and re-dissociate, thereby producing a mostly monatomic mixture of dissociated water. Preferably, steam is produced in a heat exchanger arranged about the reactor and additionally provided to the reactor to undergo thermolytic disassociation.

### CROSS-REFERENCE TO RELATED APPLICATIONS

Not Applicable

### STATEMENTS REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to the arts of disassociation of water to produce the associated resultant gaseous mixture and energy; more specifically, this invention relates to the arts of the ultra-high temperature cyclic thermal disassociation of water.

This invention relates to a new apparatus and method for the production of hydrogen, oxygen, and energy from the cyclic disassociation and combustion of water. The necessity for a commercially viable, clean source of renewable energy is only becoming more apparent. Because of hydrogen's available clean uses, apparent abundance, and appropriate combustive properties, hydrogen is looked upon as the source of energy to replace our current reliance on fossil fuels. Unfortunately, large-scale, efficient methods of hydrogen production have remained hidden from the World's brightest researchers. Many have attempted but all devised methods have inherent shortcomings.

In U.S. Pat. No. 6,977,120 B2, Chou discloses a mixed hydrogen-oxygen fuel generator system using an electrolytic solution to generate gaseous hydrogen-oxygen fuel through the electrolysis of water molecules. Electrolysis has been known for many years and has yet to become commercially viable except in the production of small quantities of high-purity hydrogen and oxygen. Generally, such electrolysis methods have weaknesses such as excessive consumption of electricity, the perilous creation of highly explosive gases, and overheating that requires the shutting down of the process. Chou attempts to overcome such shortcomings by using an electrode plate design that decreases electrical consumption, a method to create a mixed hydrogen-oxygen fuel that bums at a controlled temperature, and a cooling system that re-circulates the electrolytic solution. The claimed improvements purportedly increase the efficiency of the overall electrolysis method. However, Chou does not realize the nature of the produced gaseous hydrogen-oxygen fuel and only uses the electrolyticly-derived mixture for producing a flame with a controlled ignition temperature. The current invention does not utilize classical electrolysis of water for the disassociation of water because of its inherent inefficiencies. Electrolysis just requires too much electricity to viably produce enough hydrogen to meet demand.

Another attempt at overcoming the inherent limitations of classical electrolysis is Streckert, U.S. Pat. No. 6,939,449 B2. While Chou disclosed a low-temperature, about 30° C., apparatus and method, Streckert utilizes temperatures about 200° C. above room temperature. Streckert emphasizes the need for commercially viable, small scale electrolytic devices. Streckert still suffers from the failures of electrolysis by creating hydrogen for fuel purposes inefficiently, which leads to excessive power consumption.

Other attempts at creating an efficient device and method for the disassociation of water have been attempted using the Sun as the main source of energy. The Vialaron patent, U.S. Pat. No. 4,696,809, discloses an apparatus and method for the continuous photolytic disassociation of water. Vialaron describes the disclosed invention as a thermolytic but is more accurately described as photolytic because of the preferred use of electromagnetic radiation to achieve disassociation temperatures. Vialoron describes submerging a refractory body in water and focusing energy thereupon such that disassociation temperatures are reached. This heating creates a thin film of dissociated water about the surface of the refractory body. Submersing the refractory body in water replaces other methods of quench cooling the produced gases because the generated hydrogen and oxygen dissolve and diffuse into the water. The resultant bubbles of dissociated gasses are swept away from the refractory body by flowing water, which in turn maintains the desired temperature of the refractory body. The dissolved, produced gases are then extracted by conventional hydrogen, oxygen methods well-known in the art. The preferred embodiment describes the use of mirrors to focus electromagnetic radiation on the refractory body.

Another attempt at photolytically dissociating water is described by Pyle in U.S. Pat. No. 4,405,594 specifically as a photo separatory nozzle. Pyle describes the preferred apparatus as comprising a reflective dish that focuses solar energy, or electromagnetic radiation, upon a focal point with a concentration ratio of about or greater than 2000:1. Such is necessary to achieve the requisite temperatures to dissociate water into its constituent elements. Pyle discloses the use of a ceramic orifice, through which super-heated steam is forced, to pass over the refractory material that is the focal point of the solar energy. The sudden expansion and concomitant drop in pressure serves to retard recombination so that the lighter constituent gases, namely hydrogen, may be separated from the heavier, such as oxygen and gaseous water.

These electromagnetic dependent inventions suffer from the inherent limitations of all inventions dependent upon the use of the Sun as the electromagnetic radiation generator. This dependence results in decreased capabilities because most parts of the Earth have access to the Sun's radiation for no more than half of the day. If the device were moved to polar regions, efficiency would be decreased because of the Sun's radiation having to travel through more of the Earth's atmosphere. Also, efficiency or reflection would decrease throughout time of operation as the mirrors' surfaces become soiled.

Another method of dissociating water into hydrogen and oxygen has been disclosed by Lee in U.S. Pat. No. 6,726,893 B2. Lee discloses the well-known thermolytic disassociation of water, but provides semi-permeable membranes to drive the equilibrium of the reaction to the products, namely hydrogen and oxygen. Lee teaches that at about 1600° C., the concentrations of hydrogen and oxygen are 0.1 and 0.042%, respectively. By removing both the produced hydrogen and oxygen, the equilibrium of the disassociation reaction is driven to reactants and the disassociation can take place at lower temperatures. Lee prefers temperatures at least as high as 700° C., but preferably around 1500-1600° C., as determined by economics and engineering. Unfortunately for Lee, the economics of providing such high temperatures as required by the disassociation needs of water have traditionally limited the commercial viability thermolytic disassociation processes.

Others have addressed such limitations of thermolytic disassociation such as Vialaron as discussed above. Heller, U.S. Pat. No. 4,419,329, attempts to utilize a different approach: supplying energy to the water to be dissociated through use of ionization and magnetic fields. Heller discloses a device and method to dissociate water into hydrogen and oxygen that provides a P—N semiconductor system to ionize a stream of flowing steam. The device then heats the steam, through traditional methods, and accelerates the steam using a sweeping magnetic field, which results in molecular speeds of about 16,000 feet/second. The steam is subjected to increasing kinetic energy until it obtains an equivalent energy of about 13.5 electron-volts, at which point the steam dissociates. The dissociated gas is then passed through a porous platinum plug, which serves as a catalyst, to impart the accumulated kinetic energy to the resultant stable forms of hydrogen and oxygen. This invention suffers from the same problem of supplying heat to the water despite compensating by accelerating the steam flow through the use of the magnetic field. Heat generation is generally inefficient and dependent upon nonrenewable sources like fossil fuels.

Others have attempted to circumvent such heating inefficiencies by supplementing the addition of heat with chemical reactions, such as Baldwin, U.S. Pat. No. 6,899,862 B2. Baldwin describes a method of thermochemically dissociating water. Baldwin prefers the use of an aqueous solution of sodium hydroxide and a disassociation-initiating material such as metallic aluminum. It is thought that the sodium hydroxide solution contacts the metallic aluminum and releases hydrogen from water through a reduction-oxidation reaction. The free hydrogen is then extracted by processes well-known in the art. This invention suffers from a deficiency not present in the currently disclosed invention in that the process reaction will result in the using up of the sodium hydroxide solution and the metallic aluminum. This will result in increasing reaction inefficiencies throughout time and require the replenishment of these materials, which will increase overall hydrogen production costs. Also, a deterrent to use of thermochemical processes is the creation of toxic or dangerous materials upon degradation of the catalyst, which raises both health and economic concerns. Such is the failure of thermochemical disassociation of water.

Another innovative attempt at dissociating water is disclosed in Leach, U.S. Pat. No. 4,272,345. Leach teaches the use of heat exchangers, taking advantage of heat that would otherwise be wasted, to dissociate the water into hydrogen and oxygen. However, waste heat from normal chemical and industrial processes is insufficient to dissociate water by itself. Leach overcomes this limitation by the addition of a chemical process much as described above in Baldwin. Leach uses a different metallic catalyst, manganese oxide, but results in the same sequestration of oxygen. This technique suffers from the same deficiencies as Baldwin in that the manganese oxide will be used up and will require replenishment. In addition to the metallic catalyst, Leach teaches the use of a host and sensitizer material, such as a compound of calcium, tungsten, and neodymium, which emits coherent, monochromatic radiation at an absorption band of water, thus imparting energy to the molecule. Leach teaches a different technique for fully dissociating water. The Leach apparatus and method applies very high intensity infrared radiation to steam produced from a series of heat exchangers to excite the polar, covalent bonds of the already energetic water molecules. This further excitation results in the disassociation of the steam water to hydrogen and oxygen. A resonant cavity and high pass filtering film arrangement may be employed to shift the very high intensity infrared radiation into the ultraviolet frequency range to further excite the water molecules. The Leach patent fails in general commercial viability in that it requires a source of heat sufficient to transform water into steam outside of the disclosed techniques. The conservation of heat aspect of the Leach patent is impressive but is inappropriate for the uses of the currently-disclosed invention.

A non-hydrogen producing invention, but one that is still within the art, is disclosed by Kim, U.S. Pat. No. 6,443,725 B1. Kim discloses a heat generating apparatus, for use in commercial heating, that utilizes the cyclic combustion of Brown gas. Kim discloses that Brown gas is a gas generated in the electrolytic structures of oxyhdrogen gas generators as in Korea Utility Model Registration No. 117445, Korean Industrial Design Registration Nos. 193034, 193035, 19384266, and 191184, and Japan Utility Model Registration No. 3037633. This invention, through its dependency upon an electrolytically produced fuel, suffers from the inefficiencies associate with such fuel production as discussed above. Brown gas is disclosed as a mixture of gas that includes atomic hydrogen and oxygen dissociated from water. The Kim patent supplies ignited Brown gas to a semi-sealed combustion chamber, which has only an exhaust port. The ignited Brown gas heats the chamber to over 1000° C. through the disassociation process and teaches that the dissociated gas then recombines to water. The gaseous water is then dissociated again by the infrared rays radiated from the heated chamber walls. This patent utilizes the cyclic nature of dissociated water but fails to disclose recognize the importance of such a reaction. This patent also fails to produce mechanical work from the heat that is generated.

The current invention is superior to and distinct from the above-disclosed inventions in several ways. The current invention can use a conventional counter-current flow heat exchanger to transfer the heat associated with the disassociation and recombination of water in order to produce steam, which has many well-known, workable uses. The current invention also produces a gaseous mixture that can be used to drive a standard hydrogen fuel cell. The invention herein disclosed also produces a stable, circular, surface reaction from an abundantly available source, namely water, which can produce both usable hydrogen and oxygen and usable energy for work.

### BRIEF SUMMARY OF THE INVENTION

The current invention relates to an apparatus and method for dissociating water producing a resultant gaseous mixture composed of monatomic hydrogen (H⁺), monatomic oxygen (O²⁻), diatomic hydrogen (H₂), diatomic oxygen (O₂), hydroxyl (OH⁻), and water (H₂O) and energy using ultra-high temperature cyclic thermal disassociation. Use of the apparatus may begin by igniting an initial mixture of dissociated water and aiming the stream produced at a target material within a reactor tube. The flow of the gaseous mixture entering the reactor tube is controlled by a valve, which also serves to control the temperature of the reaction. The initial mixture of dissociated water will have a greater concentration of monatomic hydrogen and monatomic oxygen and is produced by any of the well-known methods in the art. An arc or laser can be used to ignite the stream of gaseous mixture into a plasma-like state. The arc or laser may be maintained throughout the process, which increases the overall efficiency of production of the resultant gaseous mixture and energy, or the arc or laser may be ceased while still producing the resultant gaseous mixture and energy.

The stream of the gaseous mixture is directed through a reactor tube at a target material creating a reaction area at the surface of the target material. The target material preferably has a high refractory index, a demonstrated ability to resist the containment of heat, a molecular structure susceptible to the absorption of monatomic hydrogen, and a porous structure. Target materials with the desired and demonstrated qualities include aluminum silicate, platinum group metals, and graphite foam. The target material can be placed as a block within the reactor tube or can line the reactor tube.

The efficiency of the system is dependent upon the surface area of the target material because the observed phenomenon occurs about the surface of the target material. The tube configuration is the least efficient, while the U-shaped and W-shaped configurations are intermediately efficient, and while the six-pointed star configuration is yet more efficient. More efficiency can be obtained by decreasingly tapering the area through which the ignited plasma-like gaseous mixture flows from the entrance to the exit of the reactor tube as the ignited gaseous mixture travels down the length of the reactor tube.

It is thought that the monatomic hydrogen reacts with the target material, or gets trapped by the target material, and creates a region of increased positive charge. This, in turn, causes the congregation of the negatively-charged monatomic oxygen atoms. The congregation of negatively-charged monatomic oxygen results in the increased strength of the negatively-charged area, which overpowers the monatomic hydrogen's affinity for the target material such that the monatomic hydrogen and monatomic oxygen recombine to form water. Upon recombination, there is a concomitant production of energy. It is believed that the energy produced from the recombination excites the water created from a neighboring reaction and dissociates that molecule to result in monatomic hydrogen and monatomic oxygen. The resultant monatomic hydrogen and monatomic oxygen are then free to repeat the process of separation, charge congregation, and recombination to water; or, they are free to flow out of the reactor tube.

Once out of the reactor tube, the resultant mixture of dissociated gas can be used again in several configurations. It is preferred that the resultant dissociated gaseous mixture be passed through a flashback arrestor so as to both quench cool and dehydrate the product stream as well as prevent flashback and cessation of the reaction cycle. The dissociated gas mixture retains a sufficiently high concentration of hydrogen ions so that it may be used in a standard hydrogen fuel cell. The resultant gaseous mixture can also be used exclusively or in conjunction with hydrocarbon fuels as a fuel additive to run a standard internal combustion engine. Most importantly, the resultant gaseous mixture of dissociated water can be recycled such that it reenters the reactor tube and proceeds through the cyclic disassociation reaction again until being swept away. Because the resultant gaseous mixture can be recycled to combine with the initial mixture of dissociated water to supply the reactor with reactants, flow of such initial gaseous mixture may be decreased. This recirculation of the resultant gaseous mixture also indicates, and as has been shown, that the mixture can supply a second and third reactor with each reactor's need of an initial gaseous mixture of dissociated water. These second and third reactors can be arranged, either simultaneously or independently, in series or parallel configurations.

In order to take advantage of the excess heat generated by the reaction, an industry-standard heat exchanger is placed about the reactor tube. The heat generated by the reactor tube is more than sufficient to produce workable steam from the water supplied to the heat exchanger. One skilled in any art associated with the supplication of heat necessary for a reaction or phase change will recognize the utility of the disclosed invention. Also, the steam provided can be used in any number of devices that require the use of steam to provide work. The steam generated can be used in subsequent heat exchangers to provide heat for any purpose that requires the achievement of temperature change. The above-disclosed series and parallel arrangements of reactors can be designed such that the reactors can be placed in a single heat exchanger body so that the inlet flow of heat exchanger fluid can be increased to provide for increased output of steam. Also, this arrangement allows for more heat to be supplied to chemical reactions to increase the reactivity and drive the reaction to produce more products. The use of the heat exchanger also protects the integrity of the materials used to form the reactor tube from thermal decomposition and degradation.

Another embodiment of the current invention provides steam to the reactor tube so that the production of hydrogen, oxygen, and the resultant gaseous mixture can be increased. The steam that enters the reactor tube is excited by the heat generated by the reaction such that upon entry it dissociates. The entering, dissociating steam provides more reactants to participate in the cyclic reaction of disassociation, charge congregation, recombination, and subsequent disassociation. However, the available steam must be maintained at a sufficiently low pressure so as to not lower the reaction temperature so much so that the reaction cycle is ceased. The reaction provides enough heat to the heat exchanger to provide both the steam input into the reactor tube to provide more reactants and a product stream of steam to provide work for other independent processes. The input of steam to the reactor tube also increases the output of hydrogen, oxygen, and the resultant gaseous mixture such that the output stream of the reactor tube can provide enough gaseous mixture to be recycled as well as enough to create a product stream of hydrogen and oxygen, which can then be separated into usable hydrogen and oxygen gases using known methods or can be used in hydrogen fuel cells or combustion engines as disclosed above. The introduction of steam to the reactor tube can also provide the lone reactants for the reactor, if maintained at a sufficiently low pressure so as to not cease the reaction, so that the requirement of a recycle stream of resultant dissociated water is no longer necessary; all resultant dissociated water mixture can be diverted as products or serve as initial dissociated gaseous mixture for other reactor tubes.

The advantages of the current invention overcome the above-described art by providing an efficient, commercially viable, and clean source of energy, hydrogen, and oxygen.

### BRIEF DESCRIPTION OF THE SEVERAL VIEWS OF THE DRAWINGS

FIG. 1 is an isometric left perspective view of the apparatus.

FIG. 2 is a right cross-sectional view of the apparatus demonstrating tube target material configuration.

FIG. 3 is a right cross-sectional view of the apparatus illustrating a flow configuration with a recycle stream.

FIG. 4 is an isometric left perspective view of the apparatus demonstrating steam inlet tubes.

FIG. 5a is a right cross-sectional view of the apparatus highlighting reactor flow.

FIG. 5b is a right cross sectional view of the apparatus highlighting the heat reactor fluid flow.

FIG. 6 is an isometric left perspective view of another embodiment of the invention.

FIG. 7a is a right cross-sectional view of the invention highlighting reactor flow streams.

FIG. 7b is a right cross-sectional view of the invention highlighting heat exchanger fluid flow.

FIG. 8 is an isometric right perspective view of a target material in a U-shaped configuration.

FIG. 9 is an isometric right perspective view of a target material in a W-shaped configuration.

FIG. 9a is an isometric view of the back of a target material in a W-shaped configuration.

FIG. 10 is an isometric right perspective view of target material in 6-point star configuration.

### DETAILED DESCRIPTION OF THE INVENTION

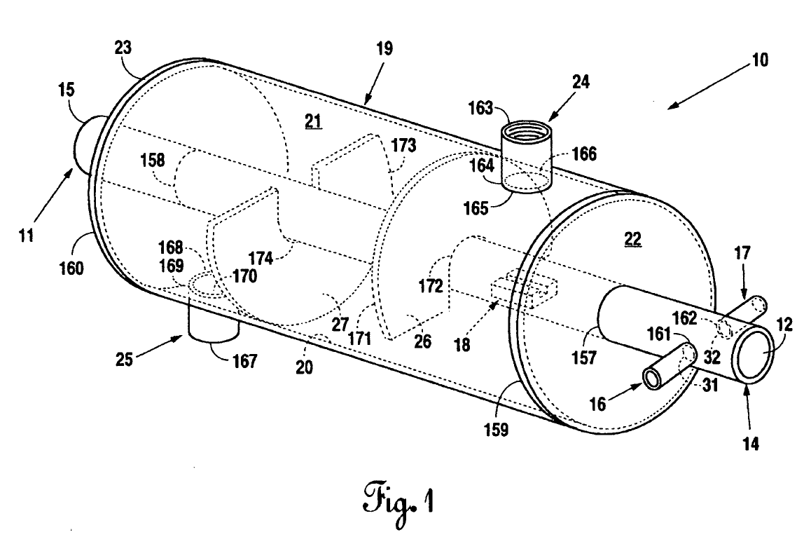

FIGS. 1 through 10 depict and illustrate some particular embodiments of a device to produce hydrogen, oxygen, and workable heat from a gaseous mixture of dissociated water. It is contemplated that one skilled in the art will see that the claimed invention can take on additional embodiments not herein described. For example, the current invention is discussed as having only two baffles within the heat exchanger body, but other configurations are heat exchangers are well known and intended to fall within the scope of this claimed invention.

FIG. 1 specifically illustrates the most basic configuration of the disclosed hydrogen, oxygen, and heat generating apparatus 10. A generally cylindrical, elongated reactor tube 11, with inner surface 12, outer surface 13, generally flat annular front edge 14, and generally flat annular back edge surface 15, is shown encased in generally cylindrical, elongated heat exchanger body 19. Heat exchanger body 19 is of greater radius than and is arranged concentrically with reactor tube 11 and comprises inner surface 20, outer surface 21, generally circular front hole 166, generally circular back hole 170, front heat exchanger cap 22, back heat exchanger cap 23, and heat exchanger flow connectors 24 and 25. Heat exchanger caps 22 and 23 are generally flat circular discs containing holes therethrough for the acceptance of reactor tube 11. Front heat exchanger cap connects to heat exchanger body 19 at front corner 159. Front heat exchanger cap 22 contacts and connects to outer surface 13 of reactor tube 11 at front corner 157. Back heat exchanger cap 23 connects to heat exchanger body 19 at back corner 160. Back heat exchanger cap 23 contacts and connects to outer surface 13 of reactor tube 11 at back corner 158. Front hole 166 extends through heat exchanger body 19 near front heat exchanger cap 22 while back hole 170 extends through heat exchanger body 19 near back heat exchanger cap 23.

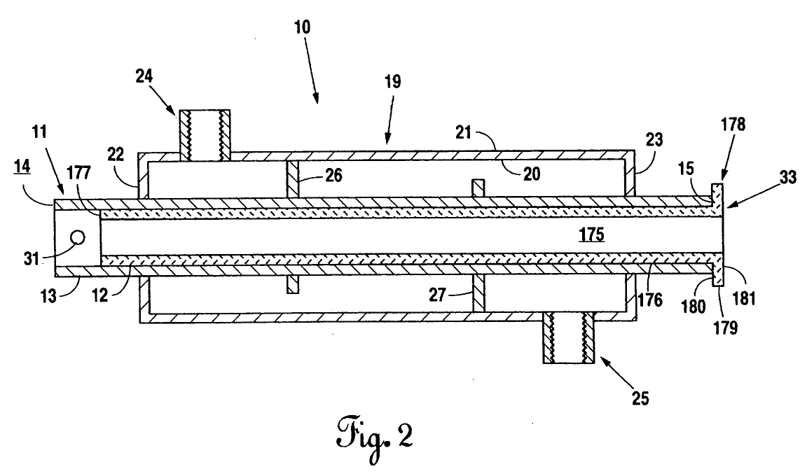

A gaseous mixture of dissociated water is directed through the entry of reactor tube 11 as defined by inner surface 12 and bound by front edge surface 14. Generally cylindrical left ignition tube 16 and generally cylindrical right ignition tube 17 are attached to reactor tube 11 and allow for an ignition source to be provided across reactor tube 11 so as to ignite the gaseous mixture of dissociated water. Left ignition tube 16 is attached to reactor tube 11 about generally circular hole 31 at corner 161. Right ignition tube 17 is attached to reactor tube 11 about generally circular hole 32 at corner 162. Holes 31 and 32 in reactor tube 11 provide access to the gaseous mixture of dissociated water. Once ignited, the stream is directed at a target material 18, shown here in a U-shaped configuration as a generally elongated rectangular prism. Target material 18 can take on other configurations as shown in FIG. 2 as target material 33 in generally cylindrical, elongated tube configuration. Target material is constructed of a material with a high refractory index, high heat capacity, a porous structure, and the ability to absorb monatomic hydrogen. Functional materials have been found to include aluminum silicate, platinum group metals, and graphite foam. Target material 18 of FIG. 1 is simply placed within reactor tube 11 so that the ignited stream of dissociated water may pass over it.

Target material 18 absorbs monatomic hydrogen from the ignited gaseous mixture of dissociated water stream in such a quantity to build localized regions of positive charge. This polarization of target material 18 attracts monatomic oxygen to congregate about the surface of target material 18. The monatomic oxygen builds an area of negative charge about target material 18 until the charge is strong enough to pull the monatomic hydrogen from target material 18, and the monatomic hydrogen and monatomic oxygen condense to form water molecules. The condensation to water molecules releases energy which can be absorbed by neighboring molecules or be transferred to reactor tube 11, through inner surface 12 and outer surface 13, to heat fluid contained in heat exchanger body 19. The dissociated water molecules are thought to generally participate in the following cyclic reaction:

2H⁻+O²⁻→H₂O+heat

H₂O+heat→2H⁻+O²⁻

Target material 18 provides the opportunity for the charged elements to separate and congregate charge. In words, the dissociated water contacts target material 18, then the monatomic hydrogen congregates on or in target material 18 and creates a region of positive charge. Monatomic oxygen congregates about the surface of target material 18 to create a region of negative charge. The strengths of the separated regions of charge increase such that they overcome the monatomic hydrogen's affinity for target material 18 to result in recombination of the monatomic hydrogen and monatomic oxygen to condense into water molecules, thereby releasing energy. The energy then contributes to the disassociation of the resultant water molecules, which can then repeat the cycle of charge congregation, recombination, energy release, and disassociation. The gaseous mixture can continue to travel the length of reactor tube 11 to the exit of reactor tube 11 as defined by inner surface 12 and bounded by back edge surface 15.

Continuing in FIG. 1, heat exchanger body 19 is configured about reactor tube 11 so as to pass fluid over outer surface 13 of reactor tube 11 while being bound by inner surface 20 of heat exchanger body 19, generally circular front hole 166, generally circular back hole 170, front heat exchanger cap 22, and back heat exchanger cap 23. The heat generated by the reaction within reactor tube 11 passes through inner surface 12 and outer surface 13 to be transferred to the fluid passing through heat exchanger body 19. Heat exchanger body 19 is constructed with inner surface 20, outer surface 21, front heat exchanger cap 22, and back heat exchanger cap 23. Heat exchanger fluid flows through both front heat exchanger flow connector 24 and back heat exchanger flow connector 25. Both flow connector 24 and flow connector 25 are generally cylindrical elongated tubes. Flow connector 24 comprises outer edge 163, which connects to a flow inlet stream (not shown), and inner edge 164, which connects to heat exchanger body 19 about hole 166 at corner 165. Flow connector 25 comprises outer edge 167, which connects to a fluid outlet (not shown), and inner edge 168, which connects to heat exchanger body 19 about hole 170 at corner 169. Within heat exchanger body 19 and about reactor tube 11 are baffles 26 and 27. Baffles 26 and 27 are generally flat and semi-circular and extend perpendicular to the longitudinal axes of generally elongated cylindrical concentric heat exchanger tube 19 and reactor tube 11. More specifically, front baffle 26 extends from and contacts inner surface 20 of heat exchanger body 19 at connection 171. Front baffle 26 extends to contact outer surface 13 of reactor tube 11 at connection 172. Front baffle extends beyond reactor tube 11 so as to drive the fluid within completely about reactor tube 11. Back baffle 27 extends from and contacts inner surface 20 of heat exchanger body 19 at connection 173. Back baffle 27 extends to contact outer surface 13 of reactor tube 11 at connection 174. Back baffle extends beyond reactor tube 11 so as to drive the fluid within completely about reactor tube 11. The heat exchanger's fluid's path is directed by inner surface 20 and heat exchanger baffles 26 and 27, and bounded by heat exchanger caps 22 and 23.

The heat exchanger's fluid's flow may be concurrent, such that the fluid enters at a lower temperature through front heat exchanger fluid connector 24, travels the length of reactor tube 11 about baffles 26 and 27, respectively, and exits through back heat exchanger fluid connector 25 at a higher temperature; or, the heat exchanger's fluid's flow may be counter-current such that the fluid enters at a lower temperature through back heat exchanger fluid connector 25, travels the length of reactor tube 11 about baffles 27 and 26, respectively, and exits through front heat exchanger fluid connector 24 at a higher temperature. Preferably and as described, the heat exchanger's fluid flows in a counter-current design so as to increase the efficiency of heat transfer from reactor tube 11 to the heat exchanger fluid. The heat exchanger fluid can be chemical reactants that require heat to increase the efficiency of the reaction or can be water to accomplish the phase transition to steam. Also, hydrogen, oxygen, and heat generating apparatus 10 can be utilized for any of the traditional uses of previously-known heat exchangers.

FIG. 2 most effectively demonstrates target material 33's tube configuration as well as provides a two-dimensional cross-sectional view of hydrogen, oxygen, and heat generating apparatus 10. The embodiment in FIG. 2 is the generally the same as described above, but that target material 33 is used. More specifically, generally cylindrical elongated reactor tube 11 extends concentrically through generally cylindrical elongated tube heat exchanger body 19 with front heat exchanger cap 22, back heat exchanger cap 23, front baffle 26, back baffle 27, front fluid connector 24 and back fluid connector 25. Reactor tube 11 extends through and connects to front heat exchanger cap 22 and back heat exchanger cap 23. Heat exchanger fluid flows counter-currently through heat exchanger body 19, bound by inner surface 20 and directed about outer surface 13 of reactor tube 11 by baffles 27 and 26, entering through fluid connector 25 and exiting from fluid connector 24.

Target material 33 comprises a generally cylindrical elongated tube with inner surface 175, outer surface 176, front edge 177, and back lip 178. Back lip 178 of target material 33 comprises outer edge 179, front surface 180, and back surface 181. Target material 33 extends through and contacts inner surface 12 of reactor tube 11 with outer surface 176. Target material 33 extends from a location in reactor tube 11 posterior to the location of holes 31 and 32 (not shown) out the exit of reactor tube 11 as defined by inner surface 12 and bound by generally flat, annular back edge 15. Back lip 178 extends radially outward such that front surface 180 of back lip 178, extending generally perpendicularly from outer surface 176 to outer edge 179, contacts back edge 15 of reactor tube 11. A gaseous mixture of dissociated water enters generally cylindrical elongated reactor tube 11, which is lined by target material 33, through the entrance to reactor tube 11 as defined by inner surface 12 and bound by front edge 14 of reactor tube 11. Generally circular hole 31 extends through reactor tube 11 to allow for an ignition device to ignite the stream of gaseous mixture of dissociated water. In this figure, hole 31 is associated with left ignition tube 16, which cannot be seen. An arc, laser, or other ignition device is allowed access to ignite the stream of gaseous mixture of dissociated water through holes 31 and 32 (not shown). The ignited mixture is directed down the center of target material 33 and reactor tube 11. The cyclic reactions of charge congregation, recombination and condensation, energy release, and re-disassociation take place throughout the length of target material 33, at target material surface 175, and reactor tube 11, but have been found to be more prominent at node points along the length of inner surface 175 of target material 33. For example, through thermal imaging, it has been shown that for a ½ inch diameter reactor tube 11 and a flow rate of 2 liters per minute, the reaction is strongest at 1.5 inch increments down the length of reactor tube 11. FIG. 2 also clearly shows a two-dimensional representation of the path of the heat exchanger fluid through heat exchanger fluid connector 25, about outer surface 13 of reactor tube 11, about baffles 27 and 26, respectively, and exiting out of heat exchanger fluid connector 24. More specifically, fluid enters connecter 25 at outer edge 167 and flows through to inner edge 168, entering heat exchanger body 19. Once inside, the fluid travels past reactor tube 11, bounded by back heat exchanger cap 23 and baffle 27. The fluid then takes a u-turn towards front heat exchanger cap 22 about baffle 27, due to the boundary of inner surface 20 of heat exchanger body 19, so as to pass over outer surface 13 of reactor tube 11 for a second time. The fluid completely passes over outer surface 13 of reator tube 11 to take another forward u-turn toward front heat exchanger cap 22 about baffle 26, due again to the boundary of inner surface 20 of heat exchanger body 19. The fluid then completely passes over outer surface 13 of reactor tube 11 for a third time to exit heat exchanger body 19 through hole 166. The fluid finally flows out through connector 24 from inner edge 164 to outer edge 163. Throughout the three passes of the heat exchanger fluid about the outer surface 13 of reactor tube 11, heat is transferred from reactor tube 11 to the heat exchanger fluid throughout the length of reactor tube 11. Again, inner surface 20 of heat exchanger body 19 and front and back heat exchanger caps 22 and 23, respectively, bound the heat exchanger fluid flow.

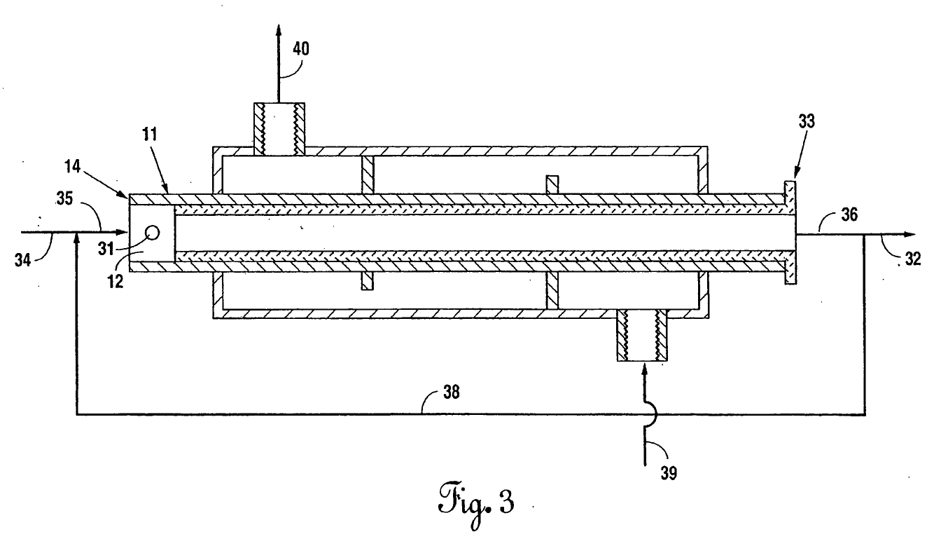

FIG. 3 discloses and defines useful streams associated with hydrogen, oxygen, and heat generating apparatus 10 with resultant gaseous mixture of dissociated water recycle stream 38. For purposes of example, reactor tube 11 contains target material 33 in generally cylindrical elongated tube configuration. Reactor input stream I 34 combines with reactor recycle stream 38, before entering reactor tube 11 through the entrance defined by inner surface 12 and bound by front edge 14, to form reactor input stream II 35. Reactor recycle stream 38's flow rate can be equal to zero such that the only source of reactants is reactor input stream I 34. Reactor input streams I and II, 34 and 35, respectively, and reactor recycle stream 38 are composed of a gaseous mixture of dissociated water containing mostly monatomic hydrogen and monatomic oxygen. Reactor input stream II 35 is ignited by an arc or laser through holes 31 and 32 (not shown) in reactor tube 11 and directed down the center of reactor tube 11 and target material 33. Reactor output stream 36 can be split, after exiting reactor tube 11 and back lip 178 of target material 33 and preferably flowing through a flashback arrestor (not shown), into reactor product stream 37 and reactor recycle stream 38, all of which generally have the same composition of monatomic hydrogen, monatomic oxygen, and associated gasses. Reactor output stream 36 will generally have a higher water content than the other streams such that it is preferable to flow reactor output stream 36 through a flashback arrestor to remove such water molecules. Reactor product stream 37's flow rate can be decreased so that at least a portion of reactor output stream 36 is recycled through reactor recycle stream 38.

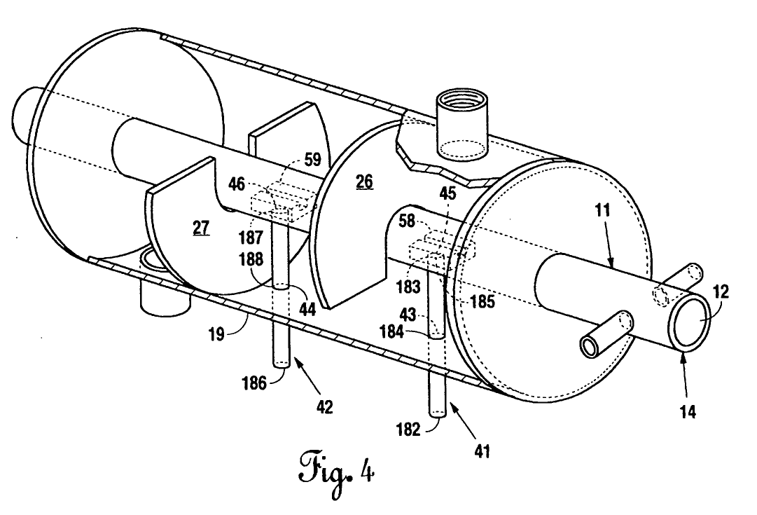

FIG. 4 discloses and illustrates the addition of generally cylindrical elongated steam inlet tubes to reactor tube 11. Steam inlet tubes 41 and 42 introduce steam to reactor tube 11 at locations determined as the specific nodes of maximum reaction, dependent upon inlet flow rate of the dissociated gaseous mixture. The specific locations of the nodes can be easily observed using infrared heat detection technology of common knowledge. Specifically, First steam inlet tube 41 introduces steam to reactor tube 11 at a distance between the entrance to reactor tube 11 as defined by inner surface 12 and bound by front edge 14 and the front baffle 26. Second steam inlet tube 42 introduces steam to reactor tube 11 at a distance between front baffle 26 and back baffle 27. First steam inlet tube 41 extends from outer edge 182 to inner edge 183. First steam inlet tube 41 extends through and contacts the edge of hole 43 in heat exchanger body 19 at connection 184. First steam inlet tube 41 continues through the heat exchanger fluid to hole 45 in reactor tube 11 and inner edge 183 contacts reactor tube 11 about hole 45 at connection 185. Second steam inlet tube 42 extends from outer edge 186 to inner edge 187. Second steam inlet tube 42 extends through and contacts hole 44 in heat exchanger body 19 at connection 188. Second steam inlet tube 42 continues through the heat exchanger fluid to hole 46 in reactor tube 11, and inner edge 187 contacts reactor tube 11 about hole 46 at connection 189. Target materials 58 and 59 are placed, in U-shaped configuration, to accept steam flowing through steam inlet tubes 41 and 42, respectively. Such placement of target materials 58 and 59 in reactor tube 11, such that target materials 58 and 59 are placed directly over holes 45 and 46, respectively, require that holes must be bored through each target material so as to provide a path through target materials 58 and 59 for the provided steam. The same can be accomplished by moving the placements of target materials 58 and 59 forward or backward so that the incoming steam has direct access to the ignited flow of the incoming gaseous mixture dissociated water. Or, the same may be accomplished by placing the U-shaped target materials opposite the incoming steam so as to accept the incoming steam in the channel defined within the U-shaped configuration, i.e. where the reaction is taking place on the inside surface of the U-shape.

FIG. 4 discloses and demonstrates two substantial elements of the claimed invention. First, the combustion and recombination of water into a dissociated gaseous mixture back into water is a cyclic reaction that can take place at several locations within one reactor tube 11. Here, target material 58 and target material 59 are illustrated and provide more surface area for the cyclic reactions to take place, resulting in increased heat generation. The addition of multiple target materials in a U-shaped configuration lead to the design of target material 33 in tube configuration to line reactor tube 11 of FIG. 2 and results in increased heat generation. The increased heat generation will cause more heat to be transferred to the fluid flowing through heat exchanger body 19, about baffles 26 and 27. Thus, if hydrogen, oxygen, and heat generating apparatus 10 is set up to impart heat to water to change the water to steam, the input flow rate through either front heat exchanger flow tube 24 or back heat exchanger flow tube 25 can be increased so as to turn more water into steam and thereby produce more energy to accomplish more work. FIG. 4 only discloses two locations for steam inlet and target material placement, but fewer locations are possible as disclosed above and more locations can be added to increase heat production and possible work.

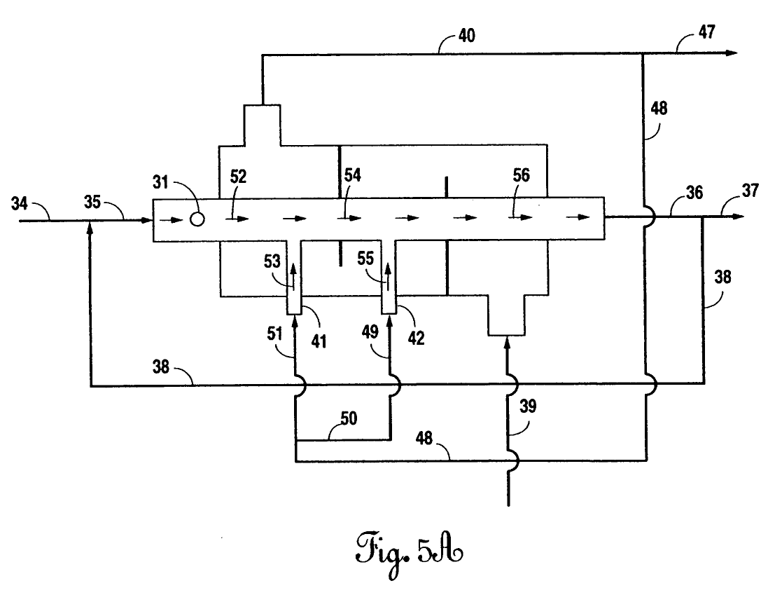

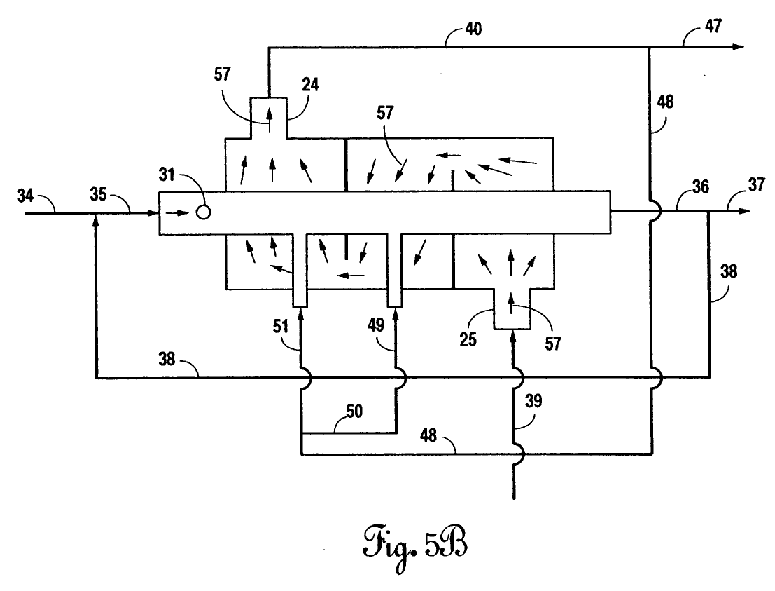

Second, FIG. 4 discloses and illustrates the addition of steam to reactor tube 11. Two locations are shown, but again, fewer or more locations are possible. The import of the introduction of steam can be more easily understood in examining FIGS. 4, 5a, and 5b in conjunction. Referring to FIG. 5a, reactor input stream I 34 combines with reactor recycle stream 38, before entrance into reactor tube 11, to form reactor input stream II 35. The composition of each of streams 34, 38, and 35 is generally the same and is a gaseous mixture of dissociated water containing almost exclusively monatomic hydrogen and monatonic oxygen. Reactor input stream II 35 enters reactor tube 11 through an entry as defined by inner surface 12 and bound by front edge surface 14. An arc or laser is activated between holes 31 and 32 in reactor tube 11, through left ignition tube 16 and right ignition tube 17 (not shown), respectively, so as to ignite the flowing gaseous mixture of dissociate water from reactor input stream II 35. Ignited reactant flow stream 52 is directed at target material 58 (shown in FIG. 4), which begins the cyclic reaction disclosed above. However, during the condensation step of the cyclic reaction, there is a concomitant pressure drop that allows steam flow stream 53 to be drawn through steam inlet tube 41 to increase the reaction production by providing more water molecules to participate in the cyclic reaction process. Ignited reactant flow stream 52 combines with steam flow stream I 53 at target material 58. Upon entry of steam flow stream I 53 to reactor tube 11, the steam molecules are immediately dissociated because of the available energy from the cyclic reaction process. Reactant flow stream II 54 is composed of a gaseous mixture of dissociated water, just as streams 34, 35, 38, and 52, but has an increased flow rate because of the addition of steam from steam input stream I 53 through first steam inlet tube 41 results in an increase of moles of the gaseous mixture of dissociated water. The above-described process is repeated at the location of target material 59 (shown in FIG. 4) and second steam inlet tube 42. Second steam inlet tube 42 extends through hole 44 in heat exchanger body 19 to hole 46 in reactor tube 11. Steam flow stream II 55 enters reactor tube 11 at target material 59 to combine with reactant flow stream II 54. Reactant flow stream II 54's cyclic reaction with target material 59 decreases the pressure within the area about target material 59 within reactor tube 11, thereby pulling into reactor tube 11 steam flow stream II 55. Steam flow stream II 55 provides more water molecules to dissociate, congregate charges, recombine and condense, release energy, and redissociate. Reactor product flow stream 56 has an increased flow rate, just as reactant flow stream II 54, due to the increase of water for disassociation. Reactor product flow stream 56 then exits reactor tube 11 as reactor output stream 36, both having the same composition of dissociated water containing mostly monatomic hydrogen and monatomic oxygen. It is preferred that reactor output stream 36 be sent to a flash back arrestor (not shown) before any secondary uses. The flash back arrestor decreases the amount of liquid water and water vapor dissolved in the gaseous mixture, quench cools the products, and prevents flashback, which would end the reaction cycle.

Just as described above with FIG. 3, reactor output stream 36 of FIG. 5a can be split into reactor product stream 37 and reactor recycle stream 38, both having the same composition of dissociated water containing mostly monatomic hydrogen and monatomic oxygen. However, as shown in FIG. 5a, the setup can be changed slightly because of the addition of steam through first and second steam inlet tubes 41 and 42, respectively. The temperatures achieved in reactor tube 11 are sufficient to maintain the cyclic reaction and drawing of steam flow stream I 53 and steam flow stream II 55, thereby providing new reactants in the form of steam. This addition of steam to reactor tube 11 through steam inlet tubes 41 and 42 theoretically allows for the flow rates of reactor recycle stream 38 and reactor input stream I 34 to both be set to zero while maintaining the cyclic reaction within reactor tube 11. Thus, the only input to reactor tube 11 may be that steam as introduced through steam inlet tubes 41 and 42. However, it has been demonstrated that steam may be produced and used in the reaction cycle and that the reactor products can obtain secondary uses. The maintenance of the cyclic reaction results in the continued generation of a gaseous mixture of dissociated water through reactor product stream 37 and generation of heat to be transferred to the heat exchanger fluid flowing through heat exchanger body 19 about baffles 26 and 27.

FIG. 5b discloses and highlights another novel feature of the present invention. Heat exchanger flow 57 is set up in classic counter-current design through heat exchanger body 19 about baffles 27 and 26, respectively. Heat exchanger input stream 39 enters heat exchanger body 19 through back heat exchanger flow tube 25. When arranged as in FIG. 5b, heat exchanger input stream 39 is liquid water. Upon entrance to heat exchanger body 19, input stream 39 becomes heat exchanger flow 57. Heat exchanger flow 57, initially liquid water, flows through heat exchanger body 19 about outer surface 13 of reactor tube 11 around baffles 27 and 26, respectively. Heat exchanger flow 57 absorbs heat generated by the cyclic reaction within reactor tube 11 and effects a phase transition to become water vapor and is such upon exiting front heat exchanger flow tube 24. Upon exit, heat exchanger flow 57 becomes heat exchanger output stream 40 and is now water vapor. Heat exchanger output stream 40 contains sufficient steam to supply both heat exchanger product stream 47 and heat exchanger recycle stream I 48. Heat exchanger product stream 47 can be used for any of the well-known uses for steam, such as operating a turbine. Heat exchanger recycle stream I 48 provides the steam used as input to reactor tube 11, through first and second steam inlet tubes 41 and 42, respectively, to result in the increased production of hydrogen, oxygen, and heat as discussed above. Steam input stream I 51 is drawn from heat exchanger recycle stream I 48 by the decrease in pressure associated with the cyclic reaction about target material 58. Heat exchanger recycle stream II 50 will have a decreased volume equal to that drawn by steam input stream I 51. Steam input stream II 49, which supplies steam to the cyclic reaction about target material 59, draws its necessary steam from heat exchanger recycle stream II 50. Currently, steam pressure must be low such that too much steam is not forced into reactor tube 11 so as to drive down the reactor temperature thereby ceasing the reaction.

The above disclosure results in the possibility to run hydrogen, oxygen, and heat generating device 10, after supplying and igniting an initial quantity of gaseous mixture of dissociated water, with reactor input stream I 34 and reactor recycle stream 38's flow rates both being set equal to zero, and only operate on input of steam to reactor tube 11. In this configuration, dissociated water will be produced and drawn off in reactor product stream 37 through only the supplying of liquid water in heat exchanger input stream 39. Also, enough steam is produced in heat exchanger body 19 to draw off product steam through heat exchanger product stream 47 while supplying the necessary steam through heat exchanger recycle stream I 48.

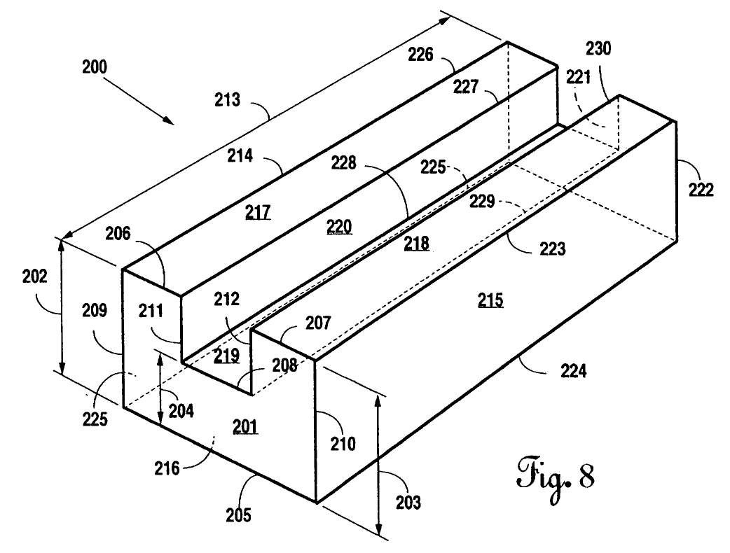

Efficiency of the reaction is determined by the amount of available surface area on which the reaction may take place. The most simple and least efficient configuration of target material is an elongated rectangular prism. Another configuration, and more efficient, is the elongated cylindrical target material of FIG. 2. However, more efficient and more preferable target material designs will now be described. Referring to FIG. 8, a more efficient U-shaped configuration is illustrated. The target material is an elongated ‘U’ with square corners. Front surface 201 of U-shaped target material 200 is a generally vertical, flat ‘U’ shape such that the vertical thickness varies throughout the width of U-shaped target material 200 and that outer heights 202 and 203 are of greater vertical span than center height 204 of U-shaped target material 200. Horizontal wall edges 205, 206, 207, and 208 are all generally parallel and horizontal. Outer horizontal wall edges 206 and 207 are generally horizontal and parallel with bottom horizontal wall edge 205 and are vertically separated from bottom wall edge 205 by a distance defined by outer heights of 202 and 203, respectively; central horizontal wall edge 208 is also horizontal and parallel with edge 205 and vertically separated from bottom wall edge 205 by a distance defined by center height 204, which is less than outer heights 202 and 203. Also, center height 204 is bound on the left by outer height 202 and bound on the right by outer height 203 so as to be located centrally between both outer heights 202 and 203. Front surface 201 is also bound by outer vertical edges 209 and 210 and inner vertical edges 211 and 212. Outer left vertical edge 209 extends vertically from bottom horizontal wall edge 205 to horizontal wall edge 206 along the distance of outer height 202. Outer right vertical edge 210 extends vertically from bottom horizontal wall edge 205 to horizontal wall edge 207 along the distance of outer height 203. Inner vertical edge 211 extends vertically between central horizontal wall edge 208 and horizontal wall edge 206, and extends vertically the distance equal to the difference between the outer vertical height 202 and center height 204. Inner vertical edge 212 extends vertically between central horizontal wall edge 208 and horizontal wall edge 207, and extends vertically the distance equal to the difference between the outer height 203 and center height 204. In summation and starting from the upper most right corner, outer vertical edge 210 extends vertically down for a distance equal to outer height 203 to bottom horizontal edge 205. Bottom horizontal edge 205 extends horizontally a distance equal to the combined lengths to horizontal edges 207, 208, and 206, respectively, to outer vertical edge 209. Outer vertical edge 209 then extends vertically upward the distance equal to outer height 202 to horizontal edge 206. Horizontal edge 206 extends inwardly to inner vertical edge 211. Inner vertical edge 211 extends vertically downward a distance equal to the difference between outer height 202 and center height 204 to horizontal edge 208. Horizontal edge 208 extends to inner vertical edge 212, which extends vertically and upwardly a distance equal to the difference in outer height 203 and center height 204 to horizontal edge 207. Horizontal edge extends horizontally outwardly to return to the uppermost right corner of front surface 201.

Continuing in FIG. 8, the general ‘U’ shape of front surface 201 is extended as if extruded through, along length 213, into three dimensions, creating outer vertical surfaces 214 and 215, horizontal bottom surface 216, horizontal top surfaces 217, 218, and 219, inner vertical surfaces 220 and 221, and back surface 222. All horizontal surfaces 216, 217, 218, and 219 are generally parallel, while horizontal top surfaces 217 and 218 are coplanar; and all vertical surfaces 214, 215, 220, and 221 are also generally parallel. Horizontal, flat surface 218 connects to and contacts vertical, flat surface 215 along corner 223, from which vertical surface 215 extends vertically downward to corner 224 and horizontal bottom surface 216. Horizontal bottom surface 216 extends horizontally to corner 225, at which horizontal bottom surface 216 contacts and connects to vertical, flat surface 214. Vertical surface 214 extends vertically and upwardly from corner 225 to corner 226, where it contacts and connects to horizontal flat surface 217. Horizontal flat surface 217 extends inwardly and horizontally to corner 227, where it contacts and connects to vertical, flat surface 220. Vertical flat surface 220 extends vertically and downwardly to corner 228, where it contacts and connects to horizontal, flat top surface 219. Horizontal top surface 219 extends generally horizontally from corner 228 to corner 229, where horizontal top surface 219 connects to and contacts vertical wall 221. Generally vertical surface 221 extends vertically and upwardly from corner 229 to corner 230 where it connects to and contacts generally flat horizontal top surface 218, which then extends horizontally to corner 223. Generally vertical back surface 222 has the same general shape as vertical front surface 201 as all corners, 223, 224, 225, 226, 227, 228, 229, and 230 extend in a parallel manner so as to allow the flat surface walls 214, 215, 216, 217, 218, 219, 220, and 221 to bound generally flat, vertical back surface 222 in the same shape as front surface 201.

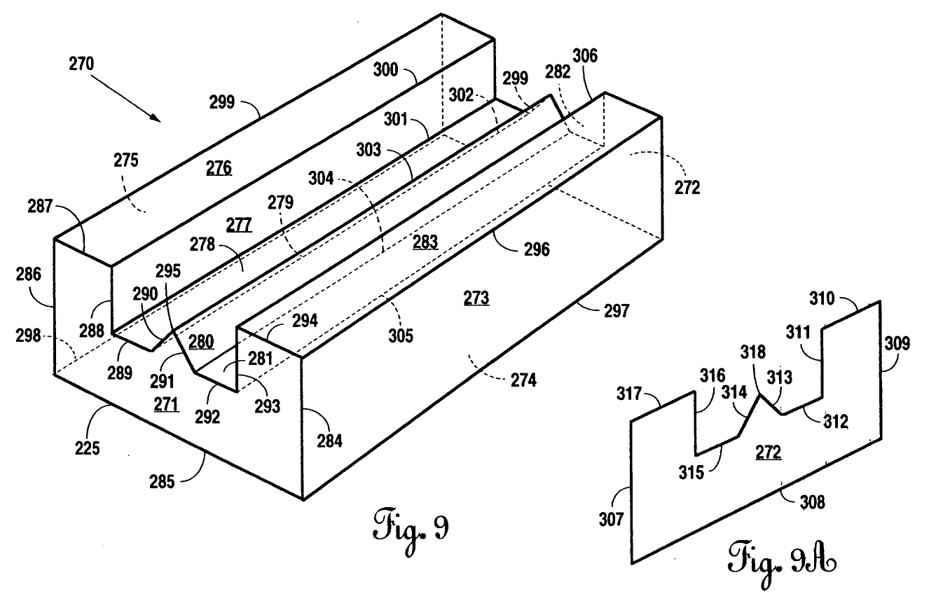

W-shaped target material configuration is illustrated in FIGS. 9 and 9a. Generally flat, vertical front surface 271 and generally flat, vertical back surface 272 are both of a general ‘W’ shape and connected by and through generally flat surfaces 273 through 283. The shape of W-shaped target material 270 is intended to increase the surface area with which the plasma-like ignited gaseous mixture may react. Specifically, the shape of front surface 271 is bound many edges 284 through 294. Outer vertical edges 284 and 286 are coplanar with and parallel to inner vertical edges 288 and 293. Bottom horizontal edge 285 is coplanar with and parallel to inner horizontal edges 289 and 292 and upper horizontal edges 287 and 294. Inner edges 290 and 291 are neither horizontal nor vertical and define the inner peak of the general ‘W’ shape of front surface 271. The general shape of front surface 271 is such that the vertical extensions of horizontal edges 287 and 294 above bottom horizontal edge 285, which are equal, are greater than the vertical extensions of inner horizontal edges 289 and 292 above bottom horizontal edge 285, which are also equal. The extensions of edges 290 and 291 above bottom horizontal edge 285 increase from initial vertical extensions equal to those of inner horizontal edges 289 and 292 to reach a greatest vertical extension above horizontal edge 285 where edges 290 and 291 meet at point 295, the top, center of front surface 271. However, the vertical extension of point 295 above bottom edge 285 is less than the vertical extensions of edges 287 and 294 above bottom horizontal edge 285.

Remaining in FIG. 9, edge 291 bounds front surface 271 and extends from point 295 outwardly and downwardly to inner horizontal edge 292, which then continues to extend outwardly but horizontally to inner vertical edge 293. Inner vertical edge 293 extends upwardly and vertically from inner horizontal edge 292 to upper horizontal edge 294. Upper horizontal edge 294 extends horizontally and outwardly to outer vertical edge 284, which extends vertically and downwardly to bottom horizontal edge 285. Bottom horizontal edge 285 then extends inwardly and horizontally, past the center point of front surface 271, to outer vertical edge 286. Outer vertical edge 286 then extends vertically and upwardly from bottom horizontal edge 285 to upper horizontal edge 287, which then extends horizontally and inwardly to inner vertical edge 288. Inner vertical edge 288 extends vertically and downwardly from upper horizontal edge 287 to inner horizontal edge 289, which then extends horizontally and inwardly to edge 290. Edge 290 extends from inner horizontal edge 289 upwardly and inwardly to contact inner edge 291 at point 295. Thus, the “W” shape of front surface 271 and W-shaped target material configuration 270 is defined.

The general shape of W-shaped target material configuration 270 is the shape of front surface 271 as if it were extruded through from two to three dimensions a distance defined by the separation between front surface 271 and back surface 272. Such extension creates surfaces to connect front surface 271 and back surface 272, which has a generally similar shape as front surface 271. Generally vertical outer surface 273 extends vertically and downwardly from corner 296 to corner 297, where it contacts and connects with generally flat and horizontal bottom surface 274. Bottom surface 274 extends horizontally and inwardly from corner 297 to corner 298 where it contacts and connects to generally vertical outer surface 275. Outer Surface 275 extends vertically and upwardly from bottom surface 274 and corner 298 to corner 299, where it contacts and connects to upper horizontal surface 276. Upper horizontal surface 276 extends inwardly and horizontally to corner 300, where it meets generally vertical and flat inner surface 277. Inner surface 277 extends vertically and downwardly from corner 300 to corner 301, where it contacts and connects to inner horizontal surface 278. Inner horizontal surface 278 extends inwardly and horizontally to corner 302 where it contacts and connects to inner point surface 279. Inner point surface 279 extends both inwardly and upwardly from horizontal inner surface 278 to corner 303, where it meets inner point surface 280. Inner point surface 280 extends outwardly and downwardly from corner 303 to corner 304 where it contacts and connects to inner horizontal surface 281. Inner horizontal surface 281 then extends outwardly and horizontally from corner 304 to corner 305, where it contacts and connects to generally vertical and flat inner surface 282. Inner surface 282 extends vertically and upwardly from corner 305 to corner 306, where it contacts and connects to upper horizontal surface 283. Upper horizontal surface 283 extends outward from corner 306 to corner 296, where it contacts and connects to vertical outer surface 273.

As shown specifically in FIG. 9a, the shape of back surface 272 is bound by many edges 307 through 317 and has the same generally shape as that of front surface 271. Outer vertical edges 272 and 309 are coplanar with and parallel to inner vertical edges 311 and 316. Bottom horizontal edge 308 is coplanar with and parallel to inner horizontal edges 312 and 315 and upper horizontal edges 310 and 317. Inner edges 313 and 314 are neither horizontal nor vertical and define the inner peak of the general ‘W’ shape of back surface 272. The general shape of back surface 272 is such that the vertical extensions of horizontal edges 310 and 317 above bottom horizontal edge 308, which are equal, are greater than the vertical extensions of inner horizontal edges 312 and 315 above bottom horizontal edge 308, which are also equal. The extensions of edges 313 and 314 above bottom horizontal edge 308 increase from initial vertical extensions equal to those of inner horizontal edges 312 and 315 to reach a greatest vertical extension above horizontal edge 308 where edges 313 and 314 meet at point 318, the top, center of back surface 272. However, the vertical extension of point 318 above bottom edge 308 is less than the vertical extensions of edges 310 and 317 above bottom horizontal edge 308.

Remaining in FIG. 9a, edge 314 bounds back surface 272 and extends from point 318 outwardly and downwardly to inner horizontal edge 315, which then continues to extend outwardly but horizontally to inner vertical edge 316. Inner vertical edge 316 extends upwardly and vertically from inner horizontally edge 315 to upper horizontal edge 317. Upper horizontal edge 317 extends horizontally and outwardly to outer vertical edge 307, which extends vertically and downwardly to bottom horizontal edge 308. Bottom horizontal edge 308 then extends inwardly and horizontally, past the center point of back surface 272, to outer vertical edge 309. Outer vertical edge 309 then extends vertically and upwardly from bottom horizontal edge 308 to upper horizontal edge 310, which then extends horizontally and inwardly to inner vertical edge 311. Inner vertical edge 311 extends vertically and downwardly from upper horizontal edge 310 to inner horizontal edge 312, which then extends horizontally and inwardly to edge 313. Edge 313 extends from inner horizontal edge 312 upwardly and inwardly to contact inner edge 314 at point 318.

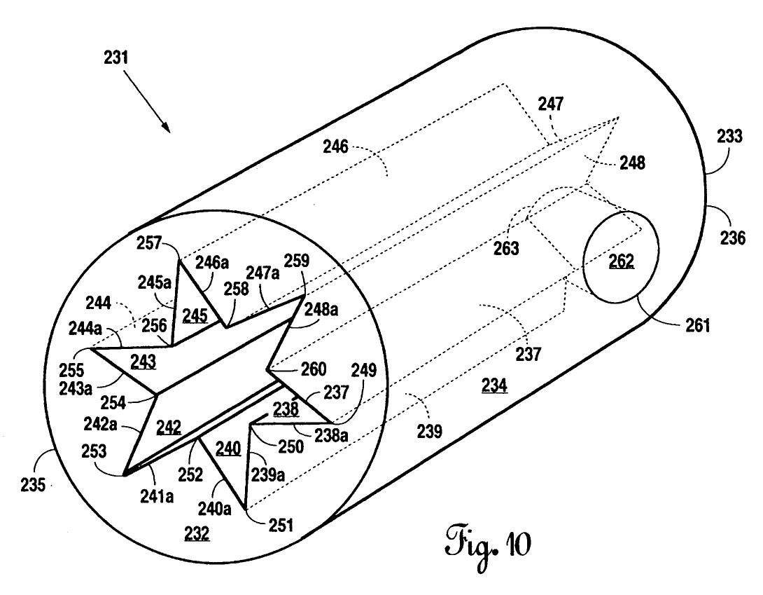

The most preferred and the expectedly most efficient embodiment of the target material is the star configuration, as shown in FIG. 10. Star-configuration target material 231 is generally an elongated cylinder with a star-shaped hole extending centrally through and down the length of the cylinder. The configuration as shown exhibits a star containing six points. The elongated star-shaped passageway and the elongated cylindrical material are concentric. Also, star-configuration target material 231 has both generally flat and vertical front and back surfaces, 232 and 233, respectively. Both front surface 232 and back surface 233 are generally circular and bounded by and connected to outer cylinder surface 234 at corners 235 and 236, respectively. Moreover, both front surface 232 and back surface 233 are perpendicular to the central axis of the elongated cylinder such that star-configuration target material 231 is generally an elongated, right cylinder. Outer cylinder surface 234 connects front surface 232 to back surface 233 so as to make one continuous outer surface 234 with corners 235 and 236. The elongated cylinder is solid but for the star-shape passageway, through which the excited plasma-like gaseous mixture is directed, as defined by inner surfaces 237, 238, 239, 240, 241, 242, 243, 244, 245, 246, 247, and 248. Each inner surface 237 through 248 is in itself an elongated rectangle connected to each neighboring rectangle along the long edges so as to form an elongated star shape. Each of the short edges contacts either front surface 232 or back surface 233 so as to produce a star-shaped hole in each. More specifically, the star-shaped hole in front surface 232 is bounded by front short edge 237a of inner surface 237 extending from inner point 260 to outer point 249; and front short edge 238a of inner surface 238 extending from outer point 249 inwardly to inner point 250. From inner point 250, front short edge 239a of inner surface 239 extends outwardly to outer point 251; and front edge 240a of inner surface 240 extends inwardly from outer point 251 to inner point 252. From inner point 252, front short edge 241a of inner surface 241 extends outwardly to outer point 253; and front edge 242a of inner surface 242 extends inwardly from outer point 253 to inner point 254. From inner point 254, front short edge 243a of inner surface 243 extends outwardly to outer point 255; and front edge 244a of inner surface 244 extends inwardly from outer point 255 to inner point 256. From inner point 256, front short edge 245a of inner surface 245 extends outwardly to outer point 257; and front edge 246a of inner surface 246 extends inwardly from outer point 257 to inner point 258. From inner point 258, front short edge 247a of inner surface 247 extends outwardly to outer point 259; and front edge 248a of inner surface 248 extends inwardly from outer point 259 to inner point 260. All outer points, 249, 251, 253, 255, 257, and 259, are closer to corner 235 than they are to the center of surface 232, and each angle at each point is equal to each other angle at each other outer point. Also, all inner points, 250, 252, 254, 256, 258, and 260, are closer to the center of surface 232 than they are to corner 235 and each angle at each inner corner is equal to each other angel at each other inner corner. Throughout the length of the cylinder, inner surface 237 extends outwardly toward outer surface 234 to contact inner surface 238 at outer point 249. Inner surface 238 then extends inwardly toward the center of the elongated cylinder to contact inner surface 239 at inner point 250. Inner surface 239 then extends outwardly to contact inner surface 240 at outer point 251. Inner surface 240 extends inwardly to contact inner surface 241 at inner point 252. Inner surface 241 then extends outwardly to contact inner surface 242 at outer point 253. Inner surface 242 then extends inwardly to contact inner surface 243 at inner point 254. Inner surface 243 then extends outwardly to contact inner surface 244 at outer point 255. Inner surface 244 then extends inwardly to contact inner surface 245 at inner point 256. Inner surface 245 then extends outwardly to contact inner surface 246 at outer point 257. Inner surface 246 then extends inwardly to contact inner surface 247 at inner point 258. Inner surface 247 then extends outwardly to contact inner surface 248 at outer point 259. Inner surface 248 then extends inwardly to contact inner surface 237 at inner point 260. At all inner points and outer points, 249 through 260, inner surfaces 237 through 248 contact both of their two neighbors, one neighbor along each long side of the elongated inner surfaces 237 through 248, so as to form the star-shaped passageway through which the excited gaseous mixture is directed.

Continuing in FIG. 10, the star-shaped hole in back surface 233 is bounded by all the back short edges, 237b through 249b, of inner surfaces 237 through 249, and more specifically, back short edge 237b of inner surface 237 extending from inner point 260 to outer point 249; and back short edge 238b of inner surface 238 extending from outer point 249 inwardly to inner point 250. From inner point 250, back short edge 239b of inner surface 239 extends outwardly to outer point 251; and back edge 240b of inner surface 240 extends inwardly from outer point 251 to inner point 252. From inner point 252, back short edge 241b of inner surface 241 extends outwardly to outer point 253; and back edge 242b of inner surface 242 extends inwardly from outer point 253 to inner point 254. From inner point 254, back short edge 243b of inner surface 243 extends outwardly to outer point 255; and back edge 244b of inner surface 244 extends inwardly from outer point 255 to inner point 256. From inner point 256, back short edge 245b of inner surface 245 extends outwardly to outer point 257; and back edge 246b of inner surface 246 extends inwardly from outer point 257 to inner point 258. From inner point 258, back short edge 247b of inner surface 247 extends outwardly to outer point 259; and back edge 248b of inner surface 248 extends inwardly from outer point 259 to inner point 260.

Remaining in FIG. 10, the star-configuration target material 231 is illustrated in tube configuration, the length of which may be short or extend the entire length of a reactor tube. However, if any tube configuration target material passes over a steam inlet tube to a reactor, there must be a hole in the target material through which the steam may access the interior of the tube and the ignited stream of gaseous dissociated water, where the reaction is taking place. In FIG. 10, such hole is defined by outer edge 261, inner surface 262, and inner edge 263. Outer edge 261 defines an orifice or aperture in outer surface 234 so as to allow steam to pass from a steam inlet tube through target material 231, past outer edge 261 in outer surface 234, bound by inner surface 262, past inner edge 263, and into the center of star configuration target material 231, where the reaction is taking place. In this configuration and as shown, outer edge 261 is a generally circular edge in outer surface 234. Inner surface 262 forms generally an elongated, right cylinder through target material 231 and contacts and connects to outer surface 234 at and about outer edge 261. Inner surface 262 extends through star configuration target material 231 and contacts and connects to inner surfaces 248, 237, 238, and 239 at inner edge 263 so as to complete the aperture through target material 231 and allow for the incoming steam to have access to the ignited gaseous stream of dissociated water.

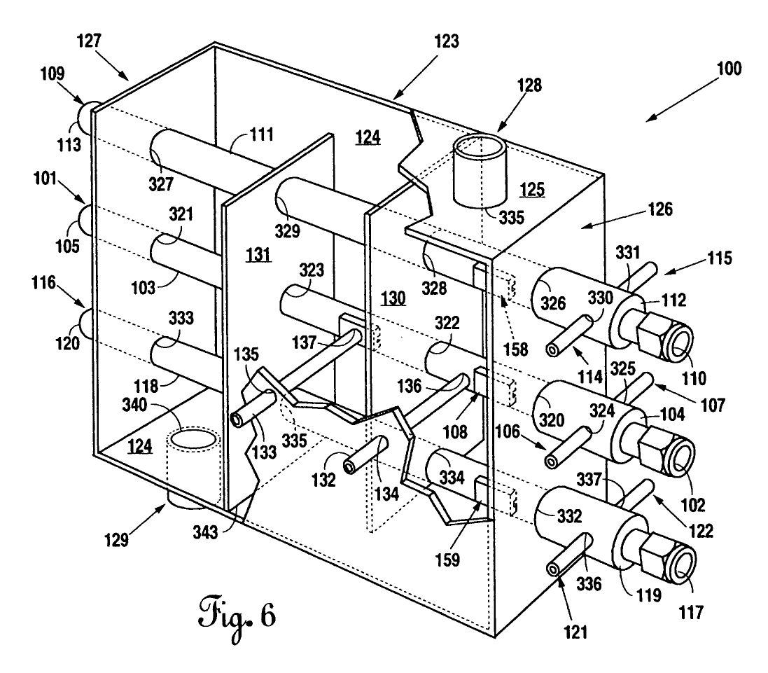

Now referring to FIG. 6, hydrogen, oxygen, and heat generating device 100 is another embodiment of the presently disclosed invention containing three reactor tubes, which can be arranged in series or parallel configuration, enclosed in a single heat exchanger body. The reactor tubes are arranged in this manner so as to increase the production of hydrogen, oxygen, and heat. Reactor tube I 101 with inner surface 102, outer surface 103, front surface edge 104, and back surface edge 105 is centrally located in heat exchanger body 123. Reactor tube I 101 extends through heat exchanger body 123, and more specifically, outer surface 103 of reactor tube I 101 connects to and extends through front heat exchanger cap 126 at edge 320. Reactor tube I 101 also extends through baffles 130 and 131 and outer surface 103 of reactor tube I 101 connects and extends through baffles 130 and 131 through edges 322 and 323 respectively. Reactor tube I 101 extends through back heat exchanger cap 127 and outer edge 103 of reactor tube I 101 connects to and extends through edge 321. Reactor tube I 101 also contains left and right ignition tubes 106 and 107, respectively, to provide access for an ignition device to the flowing mixture of dissociated water, connected to reactor tube I 101 about edges 324 and 325, respectively. Again, the stream is directed at target material 108, which provides the surface for the cyclic reaction and draws steam through first steam inlet tube 132, through the entrance to reactor tube I 101 as defined by inner surface 102 and bound by front edge 104 of reactor tube I 101. It should be noted that, with respect to all reactor tubes, the target material can be presented in a U-shape, W-shape, tube, or six-pointed star configurations, or any other that provides a sufficient surface to maintain the cyclic reaction of disassociation of steam, charge congregation, recombination, energy release, and redisassociation. First steam inlet stream 132 extends through and connects to hole 134 in heat exchanger body 123, through the heat exchanger fluid into reactor tube I 101 through hole 136 in reactor tube 101. The reaction takes places as described above with regard to hydrogen, oxygen, and heat generating device 10. FIG. 6 depicts a block configuration of target material in which two generic blocks are provided, target materials 108 and 157. Target material 157 is located so as to accept steam from second steam inlet tube 133, which extends through and connects to hole 135 in heat exchanger body 123, through the heat exchanger fluid, into reactor 101 about hole 137. Again, the above-disclosed reaction takes place about target material 157, producing more gaseous mixture of dissociated water to exit reactor tube 101 through an exit defined by inner surface 102 and bound by back surface edge 105 of reactor tube 101.

Reactor tube II 109 is defined by inner surface 110, outer surface 111, front edge surface 112, and back edge surface 113. A gaseous mixture of dissociated water enters reactor tube II 109 through an entry defined by inner surface 110 and bound by front edge surface 112. Reactor tube II 109 extends through heat exchanger body 123 located generally above the position of reactor tube I 101, and more specifically, outer surface 111 of reactor tube II 109 connects to and extends through front heat exchanger cap 126 at edge 326. Reactor tube II 109 also extends through baffles 130 and 131 and outer surface 111 of reactor tube II 109 connects and extends through baffles 130 and 131 through edges 328 and 329, respectively. Reactor tube II 109 extends through back heat exchanger cap 127 and outer edge 1111 of reactor tube II 109 connects to and extends through edge 327. Reactor tube II 109 also contains left and right ignition tubes 114 and 115, respectively, to provide access for an ignition device to the flowing mixture of dissociated water, connected to reactor tube II 109 about edges 330 and 331, respectively. FIG. 6 does not show steam inlet tubes provided to reactor 11, but one skilled in the art would readily see that steam could be provided to increase hydrogen, oxygen, and heat production. A gaseous mixture of dissociated water exits reactor tube II 109 through an exit defined by inner surface 111 and bound by back edge surface 113.

Hydrogen, oxygen, and heat generating apparatus 100 also contains reactor tube III 116, located directly below reactor tube I 101, which is defined by inner surface 117, outer surface 118, front edge surface 119, and back edge surface 120. A gaseous mixture of dissociated water enters reactor tube III 116 through an entry defined by inner surface 117 and bound by front edge surface 119. Reactor tube III 116 extends through heat exchanger body 123, and more specifically, outer surface 118 of reactor tube III 116 connects to and extends through front heat exchanger cap 126 at edge 332. Reactor tube III 116 also extends through baffles 130 and 131 and outer surface 118 of reactor tube III 116 connects and extends through baffles 130 and 131 through edges 334 and 335, respectively. Reactor tube III 116 extends through back heat exchanger cap 127 and outer edge 118 of reactor tube III 109 connects to and extends through edge 333. Reactor tube III 116 also contains left and right ignition tubes 121 and 122, respectively, to provide access for an ignition device to the flowing mixture of dissociated water, connected to reactor tube III 116 about edges 336 and 337, respectively. The gaseous mixture of dissociated water is ignited by an arc or laser, which extends across the stream through left and right ignition tubes 121 and 122, respectively. The ignited stream of dissociated water is directed at target material 159, at which the cyclic reaction takes place as disclosed above. FIG. 6 does not show steam inlet tubes provided to reactor III, but one skilled in the art would readily see that steam could also be provided to reactor tube 116 in order to increase hydrogen, oxygen, and heat production. A gaseous mixture of dissociated water exits reactor tube III 116 through an exit defined by inner surface 118 and bound by back edge surface 120.

Reactor tube I 101, reactor tube II 109, and reactor tube 116 are contained within generally elongated rectangular prism heat exchanger body 123, with inner surface 124, outer surface 125, front heat exchanger cap 126, and back heat exchanger cap 127. Heat exchanger body 123 also contains elongated cylindrical front heat exchanger flow tube 128, located on top of heat exchanger body 123 and nearest the entrances to the reactor tubes, connected to outer surface 125 at edge 338 and about hole 339, and elongated cylindrical back heat exchanger flow tube 129, located on bottom of heat exchanger body 123 and nearest the exits of the reactor tubes, connected to outer surface 125 at edge 340 and about hole 341. Heat exchanger body 123 also contains baffles 130 and 131, connected to inner surface 124 of heat exchanger body 123 at connections 342 and 343, respectively. Connection 342 extends about the about the top portions of inner surface 124 so that fluid flow may be directed down over reactor tube II 109, reactor tube I 101, and reactor tube 116, respectively in that order, and flow back up on the other side of baffle 130. Connection 343 extends about the bottom portions of inner surface 124 so as to direct fluid flow up over reactor tube III 116, reactor tube I 101, and reactor tube II 109, and back down again on the other side of baffle 131. The fluid flowing through heat exchanger body 123 can be run concurrently or counter-currently with respect to the flow within the reactor tubes. In a counter-current arrangement, heat exchanger fluid would enter heat exchanger body 123 through back heat exchanger flow tube 129, flow about outer surfaces 103, 111, and 118 of reactor tubes I 101, II 109, and III 116. The heat exchanger fluid would flow about the reactor tubes around baffles 131 and 130, respectively, all the while absorbing heat from the reactor tubes, until the heat exchanger fluid exits heat exchanger body 123 through front heat exchanger flow tube 128. Again, the heat exchanger fluid can be any chemical reactants or water transforming from liquid to vapor.

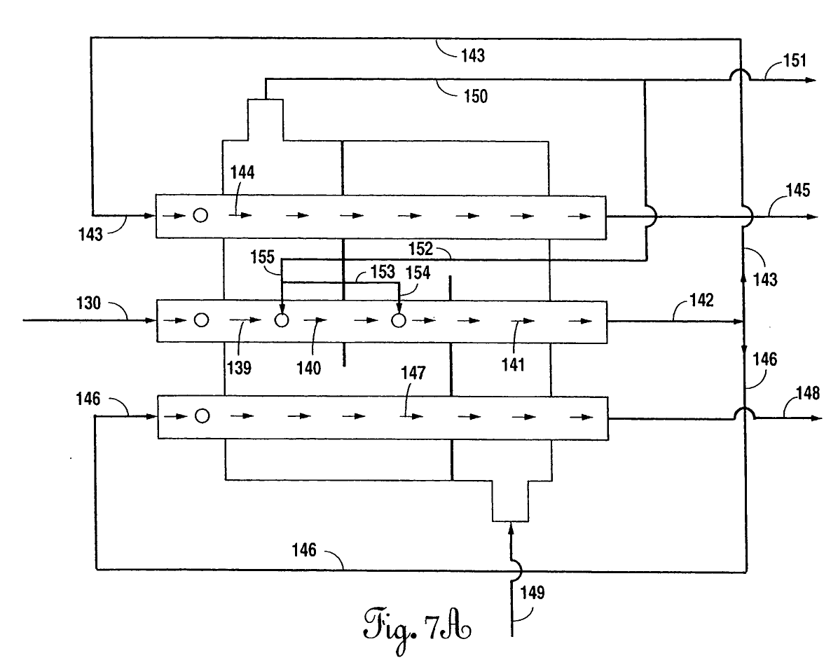

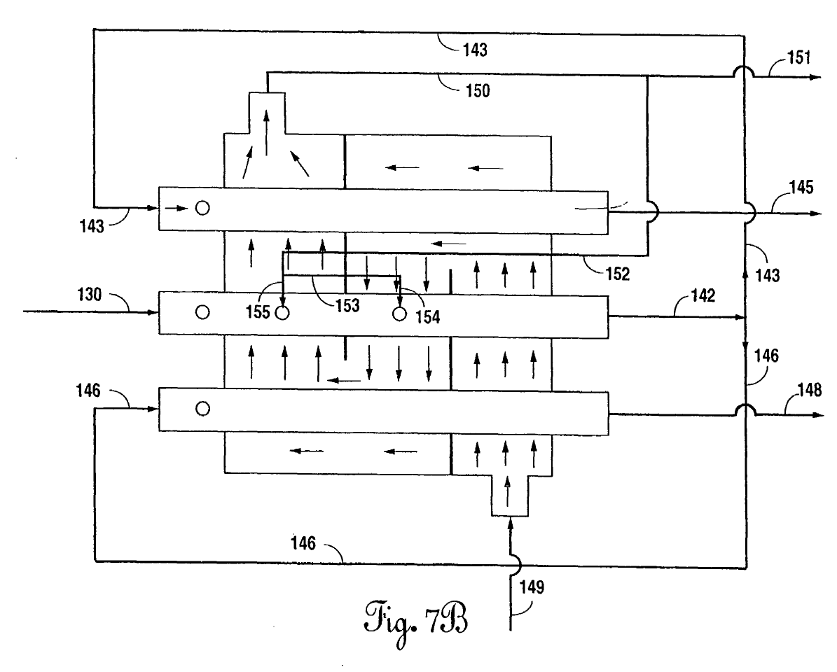

FIGS. 7a and 7b disclose and illustrate one stream configuration of hydrogen, oxygen, and heat generating device 100, in which reactor tube I 101 is arranged in series with both reactor tubes II 109 and III 116, which are arranged in parallel configuration. One skilled in the art would readily realize multiple similar configurations such as a complete series arrangement in which reactor tube I 101 produces reactants for reactor tube II 109 that then produces reactants for reactor tube III 116. Reactor tube I input stream 138 enters reactor tube I and is ignited to produce reactant flow stream I 139. Reactant flow stream I 139 is combined with steam from steam input stream I 155 to react as disclosed above about a target material not shown for ease of flow understanding. The steam from steam input stream I 155 immediately dissociates in reactor tube I 101 and participates in the cyclic reaction, in conjunction with reactant flow stream I 139, about a target material to produce reactant stream II 140. Reactant stream II 140 then combines with steam, which immediately dissociates, from steam input stream 154 and reacts about the surface of target material, not shown, to produce reactor tube I product flow stream 141. Reactor tube I product flow stream 141 then exits reactor tube 101 to become reactor tube I product stream 142, which, after having been passed through a flashback arrestor (not shown), has the same composition and flow rate as reactor tube I product flow stream 141. In the presented configuration, reactor tube I product stream 142 is split between reactor tube II recycle input stream 143 and reactor tube III input stream 146, all having the same composition of dissociated water, which contains mostly monatomic hydrogen and monatomic oxygen.

Reactor tube II recycle input stream 143 then enters reactor tube II 109 and is ignited by an arc or laser to become reactor tube II flow stream 144. Reactor tube II flow stream 144 then reacts in the manner disclosed above about the surface of a target material not shown for ease of flow understanding. Reactor tube II flow stream 144 then exits reactor tube 109 as reactor tube II product stream 145, having the same composition of dissociated water as reactor tube II flow stream 144. In the illustrated configuration, reactor tube II product stream is drawn off as product for use in well-known hydrogen-oxygen separation processes.

Reactor tube III recycle input stream 146 then enters reactor tube III 116 and is ignited by an arc or laser to become reactor tube I flow stream 147. Reactor tube III flow stream 147 then reacts in the manner disclosed above about the surface of a target material not shown for ease of flow understanding. Reactor tube III flow stream 147 then exits reactor tube 116 as reactor tube III product stream 148, having the same composition of dissociated water as reactor tube III flow stream 148. In the illustrated configuration, reactor tube III product stream is also drawn off as product for use in well-known hydrogen-oxygen separation processes.

Referring specifically to FIG. 7b, which shows the heat exchange production of steam for use in reactor tube I 101, Heat exchanger input stream 149 enters heat exchanger body 123 through back heat exchanger flow tube 129. In this configuration, heat exchanger input stream 149 is composed of liquid water. Heat exchanger flow 156 travels about the outer surfaces 103, 111, and 118 of reactor tubes I 101, II 109, and III 116. Heat is transferred from the reactor tubes to heat exchanger flow 156 to accomplish, as here, the phase transition of water to steam; but in other configurations, the heat transfer could drive the thermodynamics of a chemical reaction to increase production of products. Heat exchanger flow 156 continues in counter-current flow around baffles 131 and 131, respectively, and exits heat exchanger body 123 through front heat exchanger flow tube 128 to become heat exchanger output stream 150. Here, heat exchanger output stream 150 is composed of water vapor. Heat exchanger output stream 150 can be drawn off as product in heat exchanger product stream 151 or can supply any of the reactor tubes with steam to drive the cyclic reaction about target material. In this configuration, steam is drawn off as product in heat exchanger product stream 151 as well as used to supply reactor tube I 101. Heat exchanger recycle stream I 152 supplies to reactor tube I 101, through first steam inlet tube 132, the flow of which is indicated in FIG. 7b as steam input stream I 155. Heat exchanger recycle stream II 153, which is the same as heat exchanger recycle stream I 152 but for decreases associated with steam input stream I 155, provides reactor tube I 101 with steam through second steam inlet tube 133, the flow of which is indicated in FIG. 7b by steam input stream II 154. Because of the steam input to reactor tube I 101, reactor tube I input stream 138's flow rate may be decreased as the amount of steam provided is increased

Given the above disclosure for hydrogen, oxygen, and heat production, it is expected that those skilled in the art would readily recognize various configurations and uses for the disclosed invention without exceeding the scope of the following claims.

I claim:

1. An apparatus for creating a volume of hydrogen and a volume of oxygen and workable heat energy wherein an ignited volume of a gaseous mixture of dissociated water is directed at a target material wherein the apparatus comprises:
at least one reactor for flowing a gaseous mixture of dissociated water therethrough;
said reactor having a target material having the ability to absorb monatomic hydrogen and a high heat capacity and high refractory index to facilitate the cyclic reaction of thermolysis of water;
an ignition source at the entry of the reactor; and
a heat exchanger body arranged about the reactor to provide for the removal of heat from the reactor.

2. The apparatus of claim 1 wherein the entry to the reactor further comprises a metered valve for regulating the flow of dissociated water into the reactor.

3. The apparatus of claim 1 wherein the ignition source further comprises an arc.

4. The apparatus of claim 1 wherein the ignition source further comprises a laser.

5. The apparatus of claim 1 wherein the target material is aluminum silicate.

6. The apparatus of claim 1 wherein the target material has a porous structure.

7. The apparatus of claim 1 wherein the target material is a block placed inside the reactor.

8. The apparatus of claim 1 wherein the target material is U-shaped block.

9. The apparatus of claim 1 wherein the target material is a W shaped block.

10. The apparatus of claim 1 wherein the target material comprises a passageway into which a plurality of peaks protrudes inwardly to increase the surface area.

11. The apparatus of claim 11 wherein the passageway into which a plurality of peaks protrudes comprises at least six peaks arranged in a star configuration.

12. The apparatus of claim 1 wherein the target material is an elongated cylinder that lines the internal surfaces of the reactor so as to increase the surface area of reaction.

13. The apparatus of claim 1 wherein the reactor is connected to a flash-back arrestor to quench cool and dehydrate the reactor's products and prevent flashback and reaction cessation.

14. The apparatus of claim 1 wherein at least part of a stream of dissociated gaseous products from the exit of the reactor is recycled to enter the reactor.

15. The apparatus of claim 1 wherein the heat exchanger body arranged about the reactor tube to flow cooling water.

16. An apparatus for creating a volume of hydrogen and a volume of oxygen and workable heat energy wherein an ignited volume of a gaseous mixture of dissociated water is directed at a target material wherein the apparatus comprises:
a reactor for flowing a gaseous mixture of dissociated water therethrough;
said reactor having a target material having a high heat capacity and high refractory index to facilitate the cyclic reaction of thermolysis of water;
an ignition source at the entry of the reactor;
a heat exchanger body arranged about the reactor to provide for the removal of heat from the reactor; and
at least one inlet to the reactor for the introduction of steam.

17. The apparatus of claim 16 wherein the steam for the reactor is produced in the heat exchanger body arranged about the reactor.

18. A method of dissociating water, comprising:
flowing a source volume of a gaseous mixture of dissociated water through a reactor;
contacting the dissociated water with a target material in the reactor tube;
igniting the source volume of gaseous mixture of dissociated water;
removing heat from the reactor with a heat exchanger body about the reactor; and
passing the ignited stream of the source volume of a gaseous mixture of dissociated water into the reactor over the target material to absorb monatomic hydrogen and, thereby producing hydrogen, oxygen, and heat.

19. The method of claim 18 wherein at least part of a resultant gaseous mixture from the reactor is recycled and enters the reactor such that the flow of the source volume of a gaseous mixture of dissociated water may be decreased.

20. The method of claim 19 wherein steam is provided to the reactor so that such steam enters the reaction cycle.
